(19) United States
(12) Patent Application Publication
(10) Pub. No.: US 2024/0273167 A1
(43) Pub. Date: Aug. 15, 2024

(54) SYSTEMS AND METHODS FOR PHYSICAL ASSET VERIFICATION

(71) Applicant: Mintouge Ltd., London (GB)

(72) Inventor: Pietro Novelli, London (GB)

(21) Appl. No.: 18/438,017

(22) Filed: Feb. 9, 2024

Related U.S. Application Data
(60) Provisional application No. 63/484,086, filed on Feb. 9, 2023.

(51) Int. Cl. G06F 21/10; G06K 7/14; H04L 9/08

(52) U.S. Cl. CPC G06F 21/108; G06K 7/1434; H04L 9/0863

(57) ABSTRACT

In one aspect, a system for physical asset verification is presented. The system includes a computing device configured to receive asset data of a physical asset. The asset data includes a unique object identifier. The computing device is configured to generate a digital twin database based on the asset data. The digital twin database includes a digital twin of the physical asset. The digital twin is stored in an immutable sequential listing. The computing device is configured to receive an asset transfer code at a transfer point of the physical asset. The computing device is configured to authenticate, at the transfer point, the physical asset based on the unique object identifier and the asset transfer code. The computing device is configured to assign an ownership of the digital twin to a user at the transfer point based on the authentication.

### CROSS-REFERENCE TO RELATED APPLICATION

This application claims priority to, and the benefit of, U.S. Provisional App. No. 63/484,086, filed Feb. 9, 2023, the entirety of which is incorporated herein by reference.

### TECHNICAL FIELD

The following disclosure is directed to systems and methods for physical asset verification. In particular, the present disclosure is directed to systems and methods for physical asset verification, tracking, and transfer.

### BACKGROUND

Current technological solutions are insufficient to verify the authenticity and ownership of the physical asset by only scanning the barcode. Systems and methods are presented herein to that improve verification processes of authenticity and ownership for physical assets with immutable sequential listings.

### SUMMARY OF THE INVENTION

In one aspect, a system for physical asset verification is presented. The system includes a computing device configured to receive asset data of a physical asset. The asset data includes a unique object identifier. The computing device is configured to generate a digital twin database based on the asset data. The digital twin database includes a digital twin of the physical asset. The digital twin is stored in an immutable sequential listing. The computing device is configured to receive an asset transfer code at a transfer point of the physical asset. The computing device is configured to authenticate, at the transfer point, the physical asset based on the unique object identifier and the asset transfer code. The computing device is configured to assign an ownership of the digital twin to a user at the transfer point based on the authentication.

In another aspect, a method of physical asset verification using a computing device is presented. The method includes receiving asset data of a physical asset. The asset data includes a unique object identifier. The method includes generating a digital twin database based on the asset data. The digital twin database includes a digital twin of the physical asset. The digital twin is stored in an immutable sequential listing. The method includes receiving an asset transfer code from a user at a transfer point of the physical asset. The method includes authenticating, at the transfer point, the physical asset based on the unique object identifier and the asset transfer code. The method includes assigning an ownership of the digital twin to the user at the transfer point based on the authentication.

### BRIEF DESCRIPTION OF THE DRAWINGS

FIG. 1 is a block diagram of an exemplary embodiment of a system for physical asset verification;

FIG. 2 illustrates an embodiment of an immutable sequential listing;

FIG. 3 illustrates an exemplary embodiment of flowchart of a process of physical asset verification;

FIG. 4 illustrates an exemplary embodiment of a method of physical asset verification;

FIG. 5 illustrates an example computer for implementing the systems and methods as described;

FIG. 6 illustrates a system for asset certificate authentication;

FIG. 7 illustrates a machine-learning module that may be implemented in any systems and methods described herein; and

FIG. 8 illustrates a computing environment that may be implemented in accordance with certain aspects of the present disclosure.

### DETAILED DESCRIPTION

At a high level, aspects of the present disclosure are directed to physical asset verification. Aspects of the present disclosure can be used to validate and trace physical assets through use of digital twins of the physical assets. In some embodiments, aspects of the present disclosure may be used to incorporate barcode identifications into NFT transfers between two or more parties.

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

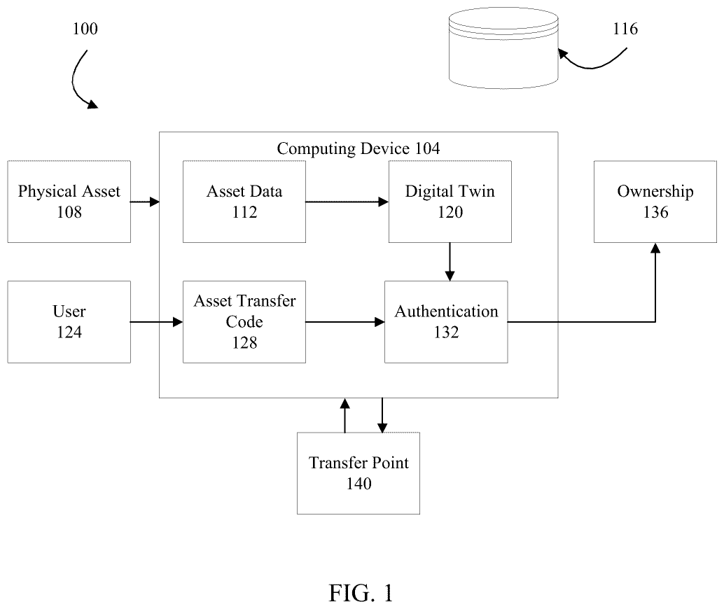

Referring to FIG. 1, system 100 for physical asset verification is presented. System 100 may include computing device 104. Computing device 104 may include a processor, memory, and the like. Computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone, or internet of things (“IOT”) device such as a smart camera. Computing device 104 may include a single computing device operating independently, or may include two or more computing device operating in concert, in parallel, sequentially or the like; two or more computing devices may be included together in a single computing device or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device, which may operate in parallel, in series, redundantly, or in any other manner used for the distribution of tasks or memory between computing devices. Computing device 104 may be implemented using a “shared nothing” architecture in which data is cached at the worker, in an embodiment, this may enable the scalability of computing device 104 and/or another computing device.

With continued reference to FIG. 1, computing device 104, and/or any other computing device as described throughout this disclosure, may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, computing device 104 may receive asset data 112 from physical asset 108. A “physical asset” as used in this disclosure is one or more objects. Physical asset 108 may include one or more types of goods, such as, but not limited to, industrial goods, consumer goods, electronics, construction materials, foodstuffs, and the like. Physical asset 108 may include a grouping of one or more objects. For instance, and without limitation, physical asset 108 may include a box of t-shirts. Computing device 104 may be configured to generate and/or receive asset data 112. “Asset data” as used in this disclosure is information pertaining to one or more objects. Asset data 112 may include, but is not limited to, dimensions of physical asset 108 such as heights, widths, lengths, volumes, and the like. In some embodiments, asset data 112 may include physical attributes such as weights, colors, materials, and/or other physical attributes. For instance and without limitation, asset data 112 may include information showing physical asset 108 is a cashmere jacket having a total weight of 1.2 lbs, a length of 2.5 feet, and a width of 1.5 feet. Computing device 104 may be configured to receive asset data 112 from one or more external computing devices, such as, but not limited to, laptops, desktops, tablets, smartphones, servers, and the like. In some embodiments, an individual may manually enter asset data 112 of physical asset 108 into computing device 104 and/or a database of computing device 104. Asset data 112 may include a unique object identifier. A “unique object identifier” as used in this disclosure a code unique to a specific object. For instance, and without limitation, a unique object identifier may include “ABC-abd-1234” which may correspond to a package of carrots. The unique object identifier of asset data 112 may include, but is not limited to, one or more QR codes, barcodes, product identification codes, manufacturer identification codes, and the like.

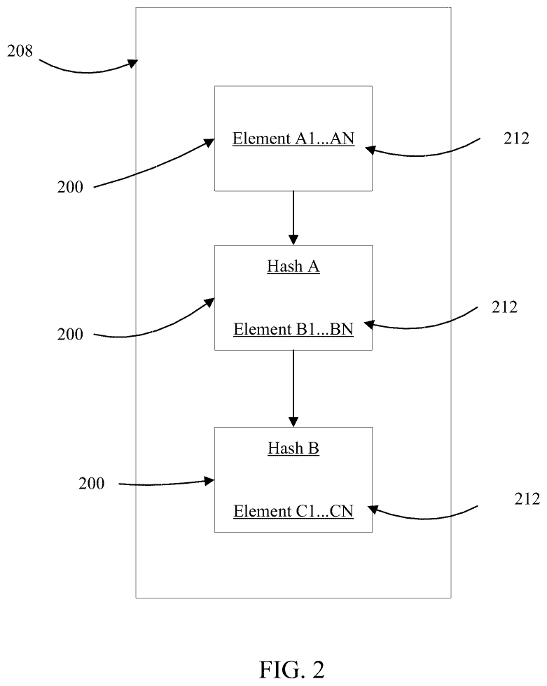

Still referring to FIG. 1, computing device 104 may be configured to generate a digital twin database 116. Computing device 104 may generate digital twin database 116 based on asset data 112. For instance, computing device 104 may generate digital representations of one or more physical assets 108. A “digital twin database” as used in this disclosure is a database that stores digital data associated with physical assets. Digital twin database 116 may include non-fungible tokens (NFT's) corresponding to one or more physical assets 108. In some embodiments, digital twin database 116 may include tokens on a block chain, soul bound tokens, and/or other digital tokens linked to one or more physical assets. Digital twin database 116 may include a hierarchical, network, object-oriented, relational, and/or other database type. Digital twin database 116 may be implemented as a SQL, NoSQL, and/or other database. In some embodiments, digital twin database 116 may include one or more NFT's linked to one or more physical assets. Digital twin database 116 may be generated as new asset data 112 is entered and/or received at computing device 104. In an embodiment, computing device 104 may be programmed and/or configured to generate an NFT from asset data 112 of physical asset 108. An NFT may be generated utilizing a hashing algorithm as described in further detail below with reference to FIG. 2.

Referring still to FIG. 1, computing device 104 may generate digital twin 120 of one or more physical assets 108. A “digital twin” as used in this disclosure is a digital representation of an object. Digital twin 120 may include a visual representation of physical asset 108. A visual representation may include a two-dimensional and/or three-dimensional image of physical asset 108. In some embodiments, a visual representation of digital twin 120 may include one or more digital views of physical asset 108, such as, without limitation, front, side, rear, top, left, right, bottom, and/or other views. In an embodiment, a visual representation of digital twin 120 may include a complete 3-D rendering of physical asset 108. As a non-limiting example, digital twin 120 may include a 3-D render of a pair of shoes corresponding to a counterpart real world pair of shoes. Digital twin 120 may include asset data 112, such as, but not limited to, dimensions and/or other physical attributes of physical asset 108. Digital twin 120 may include one or more manufacture ID, product ID, unique object identifiers, barcode numbers, QR numbers, and/or other identifiers of physical asset 108. Computing device 104 may store asset data 112 and/or a copy of asset data 112 in an immutable sequential listing, such as an NFT, of digital twin 120.

With continued reference to FIG. 1, computing device 104 may be configured to receive a user code of asset transfer code 128 from user 124. User 124 may be an individual, person, and the like. User 124 may provide a user code asset transfer code 128 through a server, web portal, mobile application, and the like. An “asset transfer code” as used in this disclosure is a code unique to an object being repossessed. Asset transfer code 128 may include a unique combination of numbers and/or characters that may identify user 124, barcode information of physical asset 108, and/or digital twin 120. In some embodiments, asset transfer code 128 may include a combination of user codes, seller codes, product codes, and the like. User 124 may provide a user code and a seller may provide a seller code, each code may include a unique object identifier of physical asset 108. Asset transfer code 128 may be generated by computing device 104 at a transfer point of physical asset 108. Computing device 104 may receive asset transfer code 128 at transfer point 140 of physical asset 108. A “transfer point” as used in this disclosure is a location at which an object is being repossessed. Transfer point 140 may include one or more points of sale (PoS) or other asset exchanging locations. In some embodiments, transfer point 140 may be digital. For instance, transfer point 140 may include a web-portal, mobile application, and/or other digital form. In some embodiments, transfer point 140 may be a physical location, such as in a store. User 124 may provide one or more value quantifiers at transfer point 140. A value quantifier may include fiat currency, crypto-currency, and/or other forms of value.

Referring still to FIG. 1, user 124 may provide one or more value quantifiers at transfer point 140 and receive a digital link from computing device 104. A digital link may include one or more Uniform Resource Locators (URLs) and/or one or more urchin tracing module (UTM) codes. A digital link may include UTM codes that may identify a URL, one or more asset transfer codes 128, and the like. In some embodiments, user 124 may provide one or more value quantifiers at transfer point 140 to which computing device 104 may generate a URL to a password protected webpage. Computing device 104 may communicate a URL to user 124 through text, e-mail, and/or other communications. A password of the password-protected webpage may include a unique sequence associated with one or more asset transfer codes 128, barcode numbers of asset data 112, and/or code from a UTM associated with the URL link. In some embodiments, user 124 may simply scan a unique object identifier of physical asset 108 through a user device after a transfer of physical asset 108 to user 124 at transfer point 140. Scanning physical asset 108 may trigger computing device 104 to retrieve and/or generate a user code and/or unique object identifier of physical asset 108. Computing device 104 may receive a user code of asset transfer code 128, a seller code of asset transfer code 128, and a unique object identifier of asset transfer code 128 to authenticate and/or verify ownership 136 of physical asset 108. Computing device 104 may perform a double handshake protocol, in which both parties of a transfer of physical asset 108 may provide a code identifying physical asset 108 and identifies of each party.

In FIG. 1, computing device 104 may be configured to perform authentication 132. Computing device 104 may perform authentication 132 at a server, web portal, mobile application, and/or other transfer point that may be associated with a digital link generated by computing device 104. As a non-limiting example, computing device 104 may generate a URL that directs user 124 to a webpage for transfer of digital twin 120 and/or physical asset 108. Authentication 132 may include validating asset transfer code 128, digital twin 120, and/or other data. Computing device 104 may compare asset transfer code 128 to a verified asset transfer code 128 and/or other code that may be stored in a database of computing device 104. For instance, and without limitation, authentication 132 my include comparing asset transfer code 128 with barcode information of physical asset 108, digital twin 120, and one or more remittance codes provided by a current owner of physical asset 108 that may be stored in a database of computing device 104. Authentication 132 may include receiving and verifying asset data 112, asset transfer code 128, and/or a remittance code from another user. A remittance code may include a unique sequence of characters and/or numbers that identifies an individual transferring ownership rights of physical asset 108 and/or digital twin 120. Authentication 132 may include a form of a double handshake protocol, in which a current user and/or user 124 may both provide one or more codes to computing device 104. In some embodiments, computing device 104 may receive a verification code from user 124 through, but not limited to, e-mail, SMS, NFC cards, biometric systems, and/or other verification forms. A verification code may include a code specific to user 124 that identifies user 124 and/or a device of user 124. A verification code may be combined with other codes of asset transfer code 128. Computing device 104 may use a verification code received from user 124 to authenticate asset transfer code 128 through authentication 132. For instance, a user may provide a 6-digit verification code received from a server. Computing device 104 may match the 6-digit verification code with one or more codes of asset transfer code 128. In some embodiments, a verification code may be part of asset transfer code 128. Authentication 132 may include computing device 104 triggering an application programming interface (API) request to digital twin database 116 to generate a unique user code for a specific transfer of physical asset 108. Computing device 104 may authenticate asset transfer code 128, physical asset 108, remittance codes of a user, ownership of digital twin 120, and/or other data and store the data in an immutable sequential listing. For instance, computing device 104 may add a data block to a chain of data blocks. A data block may include a timestamp, ownership information, value quantifier information, asset data 112, transfer point data, and the like. A data block may include data from a previous data block in a chain of data blocks, providing a continuity of sequential data. Authentication 132 may utilize a smart contract, as discussed below with reference to FIG. 2.

Referring still to FIG. 1, computing device 104 may generate ownership 136 based on authentication 132. Ownership 136 may include rights to one or more digital twins 120 of one or more physical assets 108. Ownership 136 may generated and/or stored in a blockchain, such as in an NFT of digital twin 120. Ownership 136 may include data showing a transfer of rights from a previous user to user 124 of digital twin 120. Computing device 104 may generate a new owner ID of ownership 136. A new owner ID may include a combination of identification of user 124, barcode information of asset data 112, and/or creator codes of digital twin 120. User 124 may transfer ownership 136 to one or more users. In some embodiments, user 124 may “unlock” a transfer process of digital twin 120 and/or physical asset 108. A transfer process may include a subsequent assignment of rights of ownership of digital twin 120 and/or physical asset 108. User 124 may list physical asset 108 on a digital marketplace and/or other transfer point.

Still referring to FIG. 1, computing device 104 may be configured to encrypt and/or decrypt any sequence, code, identifier, and the like of system 100. An “encryption process” as used in this disclosure is a process of taking plain text and converting it into cypher text. Encryption may include symmetric encryption. Encryption and decryption keys in symmetric cryptographic systems may be kept secret, and shared only with persons or entities that the user of the cryptographic system wishes to be able to decrypt the cyphertext. One example of a symmetric cryptographic system is the Advanced Encryption Standard (“AES”), which arranges plaintext into matrices and then modifies the matrices through repeated permutations and arithmetic operations with an encryption key. Encryption may include asymmetric cryptography, which includes public and private key pairings. A public key may include an algorithm and/or sequence that converts plain text into cipher text and a private kay may include an algorithm and/or sequence that decrypts cipher text into plain text. Computing device 104 may encrypt asset transfer code 128 using and may decrypt asset transfer code 128 at authentication 132.

Referring now to FIG. 2, an exemplary embodiment of an immutable sequential listing 200 is shown. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. Immutable sequential listing 200 may be, include and/or implement an immutable ledger, where data entries that have been posted to immutable sequential listing 200 cannot be altered. In some embodiments, immutable sequential listing 200 may be utilized in a smart contract. A “smart contract” as used in this disclosure is a self-executing contract with the terms of agreement between a buyer and a seller being directly written into lines of code. Immutable sequential listing 200 may be utilized in a smart contract to unalterably store transactional data such as, but not limited to, identification of parties, transferred assets, values of assets, dates, times, ownership information, and the like.

Referring still to FIG. 2, immutable sequential listing may include data elements 204. Data elements 204 may include any form of data, including textual data, image data, encrypted data, cryptographically hashed data, and the like. A collection of textual data of data elements 204 may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or cyphertext data. In an embodiment, a collection of textual data may be encrypted and/or may be a hash of other data. For instance, a collection of textual data may include a root or node of a Merkle tree or hash tree, or a hash of any other information desired to be recorded in some fashion using a digitally signed assertion. Data elements 204 may include, without limitation, one or more digitally signed assertions. Digitally signed assertions may include a collection of textual and/or other data that is signed using a secure proof. A digitally signed assertion 204 may be signed by a digital signature created using the private key associated with the owner's public key. In some embodiments, a collection of textual data may state that the owner of a certain transferable item represented in a digitally signed assertion register is transferring that item to the owner of an address.

Still referring to FIG. 2, a digitally signed assertion may describe a transfer of virtual currency, such as crypto-currency. Virtual currency may be a digital currency. In some embodiments, data elements 204 may include an item of value. An item of value may be a transfer of trust, for instance represented by a statement vouching for the identity or trustworthiness of the first entity, without limitation. An item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security. A digitally signed assertion of data elements 204 may describe a transfer of a physical good and/or a digital good. For instance, a digitally signed assertion may describe a sale of a product or other physical asset. In some embodiments, a transfer nominally of one item may be used to represent a transfer of another item. For instance, a transfer of virtual currency may be interpreted as representing a transfer of an access right. In some embodiments, where an item nominally transferred is something other than virtual currency, the transfer itself may still be treated as a transfer of virtual currency, having value that depends on a variety of potential factors including the value of the item nominally transferred and the monetary value attendant to having the output of the transfer moved into a particular user's control. An item of value may be associated with a digitally signed assertion by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

Still referring to FIG. 2, in one embodiment, immutable sequential listing 200 and/or data elements 204 may include an address. An address may include a textual datum identifying the recipient of virtual currency or another item of value in a digitally signed assertion. In some embodiments, an address may be linked to a public key, the corresponding private key of which is owned by the recipient of a digitally signed assertion. For instance, an address may be the public key. An address may be a representation, such as a hash, of the public key. An address may be linked to the public key in memory of a computing device, for instance via a “wallet shortener” protocol. In some embodiments, where an address is linked to a public key, a transferee in a digitally signed assertion may record a subsequent digitally signed assertion transferring some or all of the value transferred in the first a digitally signed assertion to a new address in the same manner. A digitally signed assertion may contain textual information that is not a transfer of some item of value in addition to, or as an alternative to, such a transfer. For instance, as described in further detail below, a digitally signed assertion may indicate a confidence level associated with a distributed storage node as described in further detail below.

In an embodiment, and still referring to FIG. 2 immutable sequential listing 200 may record a series of at least a posted content in a way that preserves the order in which the at least a posted content took place. Immutable sequential listing 200 may be accessible at any of a various security settings. For instance, and without limitation, immutable sequential listing 200 may be readable and modifiable publicly, may be publicly readable but writable only by entities and/or devices having access privileges established by password protection, confidence level, or any device authentication procedure or facilities described herein, or may be readable and/or writable only by entities and/or devices having such access privileges. Access privileges may exist in more than one level, including, without limitation, a first access level or community of permitted entities and/or devices having ability to read, and a second access level or community of permitted entities and/or devices having ability to write; first and second community may be overlapping or non-overlapping. In an embodiment, posted content and/or immutable sequential listing 200 may be stored as one or more zero knowledge sets (ZKS), Private Information Retrieval (PIR) structure, or any other structure that allows checking of membership in a set by querying with specific properties. Such database may incorporate protective measures to ensure that malicious actors may not query the database repeatedly in an effort to narrow the members of a set to reveal uniquely identifying information of a given posted content.

Still referring to FIG. 2, immutable sequential listing 200 may preserve the order in which the at least a posted content took place by listing them in chronological order. Alternatively or additionally, immutable sequential listing 200 may organize data elements 204 into sub-listings 208 such as “blocks” in a blockchain, which may be themselves collected in a temporally sequential order. Data elements 204 within a sub-listing 208 may be temporally sequential. A ledger of immutable sequential listing 200 may preserve an order in which data of data elements 204 took place by listing them in sub-listings 208 and placing the sub-listings 208 in chronological order. Immutable sequential listing 200 may be a distributed, consensus-based ledger. In some embodiments, the ledger may be a secured ledger. In one embodiment, a secured ledger may include a ledger having safeguards against alteration by unauthorized parties. The ledger may be maintained by a proprietor, such as a system administrator on a server, that controls access to the ledger; for instance, the user account controls may allow contributors to the ledger to add at least a posted content to the ledger, but may not allow any users to alter at least a posted content that have been added to the ledger. In some embodiments, ledger is cryptographically secured; in one embodiment, a ledger is cryptographically secured where each link in the chain contains encrypted or hashed information that makes it practically infeasible to alter the ledger without betraying that alteration has taken place, for instance by requiring that an administrator or other party sign new additions to the chain with a digital signature. Immutable sequential listing 200 may be incorporated in, stored in, or incorporate, any suitable data structure, including without limitation any database, datastore, file structure, distributed hash table, directed acyclic graph or the like. In some embodiments, the timestamp of an entry is cryptographically secured and validated via trusted time, either directly on the chain or indirectly by utilizing a separate chain. In one embodiment the validity of timestamp is provided using a time stamping authority as described in the RFC 3161 standard for trusted timestamps, or in the ANSI ASC x9.95 standard. In another embodiment, the trusted time ordering is provided by a group of entities collectively acting as the time stamping authority with a requirement that a threshold number of the group of authorities sign the timestamp.

In some embodiments, and with continued reference to FIG. 2, immutable sequential listing 200, once formed, may be inalterable by any party, no matter what access rights that party possesses. For instance, immutable sequential listing 200 may include a hash chain, in which data is added during a successive hashing process to ensure non-repudiation. Immutable sequential listing 200 may include a block chain. In one embodiment, a block chain is immutable sequential listing 200 that records one or more new at least a posted content in a data item known as a sub-listing 208 or “block.” An example of a block chain is the BITCOIN block chain used to record BITCOIN transactions and values. Sub-listings 208 may be created in a way that places the sub-listings 208 in chronological order and link each sub-listing 208 to a previous sub-listing 208 in the chronological order so that any computing device may traverse the sub-listings 208 in reverse chronological order to verify any at least a posted content listed in the block chain. Each new sub-listing 208 may be required to contain a cryptographic hash describing the previous sub-listing 208. In some embodiments, the block chain contains a single first sub-listing 208 sometimes known as a “genesis block.”

Still referring to FIG. 2, the creation of a new sub-listing 208 may be computationally expensive; for instance, the creation of a new sub-listing 208 may be designed by a “proof of work” protocol accepted by all participants in forming the immutable sequential listing 200 to take a powerful set of computing devices a certain period of time to produce. Where one sub-listing 208 takes less time for a given set of computing devices to produce the sub-listing 208 protocol may adjust the algorithm to produce the next sub-listing 208 so that it will require more steps; where one sub-listing 208 takes more time for a given set of computing devices to produce the sub-listing 208 protocol may adjust the algorithm to produce the next sub-listing 208 so that it will require fewer steps. As an example, protocol may require a new sub-listing 208 to contain a cryptographic hash describing its contents; the cryptographic hash may be required to satisfy a mathematical condition, achieved by having the sub-listing 208 contain a number, called a nonce, whose value is determined after the fact by the discovery of the hash that satisfies the mathematical condition. Continuing the example, the protocol may be able to adjust the mathematical condition so that the discovery of the hash describing a sub-listing 208 and satisfying the mathematical condition requires more or less steps, depending on the outcome of the previous hashing attempt. Mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, production of a new sub-listing 208 according to the protocol is known as “mining.” The creation of a new sub-listing 208 may be designed by a “proof of stake” protocol as will be apparent to those skilled in the art upon reviewing the entirety of this disclosure.

With continued reference to FIG. 2, where two entities simultaneously create new sub-listings 208, immutable sequential listing 200 may develop a fork. A protocol may determine which of the two alternate branches in the fork is the valid new portion of the immutable sequential listing 200 by evaluating, after a certain amount of time has passed, which branch is longer. “Length” may be measured according to the number of sub-listings 208 in the branch. Length may be measured according to the total computational cost of producing the branch. Protocol may treat only at least a posted content contained the valid branch as valid at least a posted content. When a branch is found invalid according to this protocol, at least a posted content registered in that branch may be recreated in a new sub-listing 208 in the valid branch; the protocol may reject “double spending” at least a posted content that transfer the same virtual currency that another at least a posted content in the valid branch has already transferred. As a result, in some embodiments the creation of fraudulent at least a posted content requires the creation of a longer immutable sequential listing 200 branch by the entity attempting the fraudulent at least a posted content than the branch being produced by the rest of the participants; as long as the entity creating the fraudulent at least a posted content is likely the only one with the incentive to create the branch containing the fraudulent at least a posted content, the computational cost of the creation of that branch may be practically infeasible, guaranteeing the validity of all at least a posted content in the immutable sequential listing 200.

With continued reference to FIG. 2, in some embodiments, virtual currency, such as crypto-currency, may utilize one or more immutable sequential listings 200. Crypto-currency may include Bitcoins, Peercoins, Namecoins, and/or Litecoins. Crypto-currency may be decentralized, with no particular entity controlling it; the integrity of the crypto-currency may be maintained by adherence by its participants to established protocols for exchange and for production of new currency, which may be enforced by software implementing the crypto-currency. Crypto-currency may be centralized, with its protocols enforced or hosted by a particular entity. For instance, crypto-currency may be maintained in a centralized ledger. In lieu of a centrally controlling authority, such as a national bank, to manage currency values, the number of units of a particular crypto-currency may be limited, the rate at which units of crypto-currency enter the market may be managed by a mutually agreed-upon process, such as creating new units of currency when mathematical puzzles are solved, the degree of difficulty of the puzzles being adjustable to control the rate at which new units enter the market. Mathematical puzzles may be the same as the algorithms used to make productions of sub-listings 208 in a block chain computationally challenging; the incentive for producing sub-listings 208 may include the grant of new crypto-currency to the miners. Quantities of crypto-currency may be exchanged as described above.

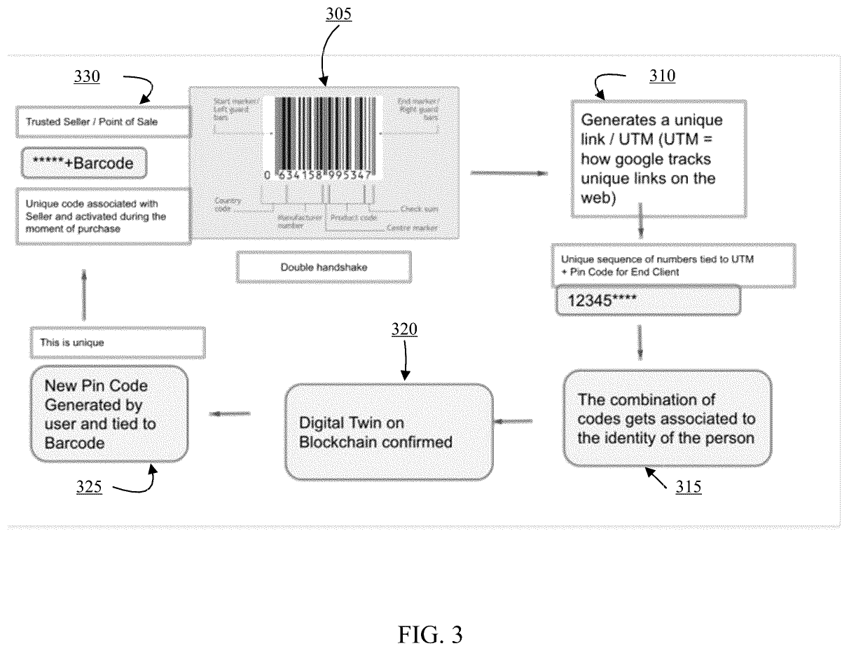

Referring now to FIG. 3, a flowchart 300 of physical asset authentication is presented. At step 305, a barcode of a physical asset is scanned. In some embodiments, at step 305, a QR or other code may be scanned. A barcode may be scanned through one or more scanning devices such as a barcode scanner. A barcode of a physical asset may be digitally associated with a digital twin of the physical asset, such as described above, without limitation, in FIG. 1. The barcode information may include data such as manufacture ID, product ID, physical attributes, relative value, and the like.

At step 310, and continuing to refer to FIG. 3, a unique link is created. A unique link may include one or more UTM codes and/or URL links. A unique link may include a sequence of numbers and/or characters, such as a pin code. A unique link may include a combination of barcode information and a generate password, such as a pin code.

Still referring to FIG. 3, at step 315, the combination of codes of the unique link is associated to an identity of a user. For instance, the unique link including the barcode information and the pin code may be associated with a username, device ID, server ID, MAC address, and/or other identifications.

Referring still to FIG. 3, at step 320, a computing device validates and/or verifies the unique link identifies a digital twin of the physical asset on a blockchain. For instance, a computing device confirms the unique link is associated with a digital twin stored on a blockchain.

Referring still to FIG. 3, at step 325 a new code is generated that is associated with a barcode of a physical asset. The new code may include a pin code in combination with a barcode of a physical asset. A computing device may communicate the unique code to a user device, such as through an e-mail, text message, and the like.

Still referring to FIG. 3, at step 330, a transfer of the physical asset occurs. A user may provide a unique pin code tied to a barcode of a physical asset and a current owner may provide a unique code associated with the physical asset and/or a digital twin of the physical asset. This step may include a “double handshake” protocol. For instance, a current owner may provide a unique code that acknowledges the physical asset and/or digital twin is ready for transfer and a user may provide a unique code that indicates the user is requesting ownership of the physical asset and/or digital twin of the physical asset. A computing device may authenticate two or more codes of a user and/or current owner and transfer ownership of the physical asset and/or digital twin to the user from the current owner. This transfer may be stored in an immutable sequential listing, such as a blockchain. Step 330 may be implemented utilizing a smart contract, as described above with reference to FIG. 2.

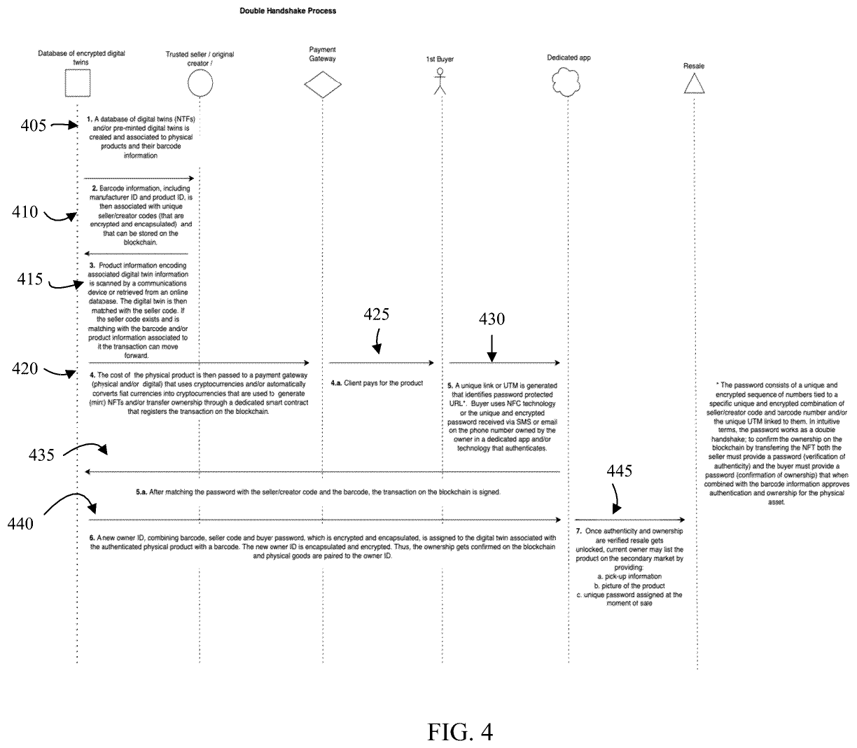

Referring now to FIG. 4, another flowchart of physical asset transfer is presented. At step 405, a database of digital twins is created by a computing device. Digital twins may include NFTs representing real-world counterparts, such as physical assets. The NFTs of the digital twin database may include barcode information, manufacture ID, product ID, and the like.

Still referring to FIG. 4, at step 410, unique creator codes are generated based on the barcode information. Creator codes may include a unique combination of characters, strings, symbols, and the like. In some embodiments, a creator code may include a pin code. Creator codes may include remittance codes as described above with reference to FIG. 1. Creator codes may include a pin code in combination with a barcode ID of a physical asset. A creator code may be encrypted using an encryption method, such as described above with reference to FIG. 1.

Still referring to FIG. 4, at step 415, asset data of a physical asset is scanned and/or retrieved from a database. As a non-limiting example, a barcode of a physical asset may be scanned at a transfer point, such as a store, marketplace, and the like. A computing device may match information from scanned asset data of a physical asset with a digital twin of the physical asset of a digital twin database and/or with a creator code. A computing device may confirm the unique creator code generated at step 410 is valid and matches asset data information, such as barcode information, of the physical asset.

Still referring to FIG. 4, at step 420, a computing device facilitates a transfer of ownership of the physical asset and/or digital twin. For instance, the physical product may be exchanged for one or more value quantifiers, such as fiat currency, crypto currency, and the like. A computing device may utilize one or more smart contracts that may store and transactions of a physical/digital asset on a blockchain.

Still referring to FIG. 4, at step 425, a user distributes one or more value quantifiers to one or more computing devices, users, organizations, and the like. Value quantifiers may include fiat currency, crypto currency, and the like.

Still referring to FIG. 4, at step 430, a unique link is generated by the computing device. The unique link may include a URL that may direct a user to a password-protected website. Generating a unique link may include generating one or more UTM codes that may identify a user, creator, digital twin, and the like. A user may utilize near-field communication (NFC) technology at a transfer point. For instance, a user may utilize NFC technology between a PoS system and a smartphone. In some embodiments, the computing device may generate a text and/or email on a phone number owned by an owner of the physical asset in a dedicated app and/or other technology that authenticates the unique code.

Still referring to FIG. 4, at step 435, the password of the creator code is matched with the barcode of the physical asset. If the barcode information matches the information of the creator code and/or user code, the computing device stores the transfer on a blockchain. The transaction may be digitally signed by a current owner and/or user.

Still referring to FIG. 4, at step 440, a new owner of a physical asset and/or digital twin is assigned by the computing device. The computing device may generate a new owner ID, which may combine the barcode of the physical asset, a creator code, and/or a user password. The new owner id may be encrypted and/or encapsulated and may be assigned to a digital twin associated with the authenticated physical product with a barcode. The new owner ID may be stored on the blockchain.

Still referring to FIG. 4, at step 445, the new owner may unlock the digital twin for redistribution. The new owner may list the physical asset on a marketplace and/or other transactional transfer point. The new owner may provide pick-up information of the physical asset, such as a geographical location, street, city, state, zip code, time, date, and the like. The new owner may provide a picture of the physical asset to a transfer point, such as a digital marketplace. The new owner may also provide a unique password assigned at a transfer of the physical asset.

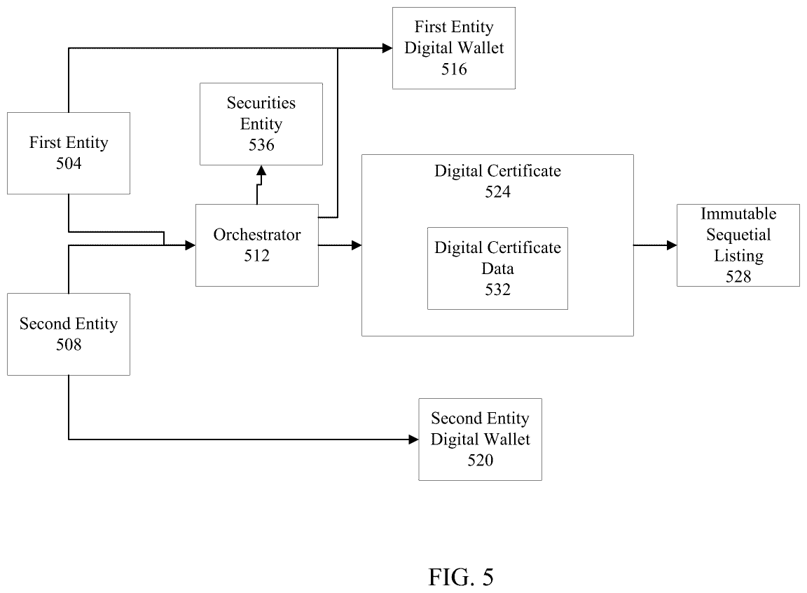

Referring now to FIG. 5, a system 500 for asset insurance is illustrated. System 500 may include first entity 504 and/or second entity 508. First entity 504 and/or second entity 508 may be an individual, organization, and/other being. In some embodiments, first entity 504 may have first entity digital wallet 516. First entity digital wallet 516 may be any digital wallet, for instance, a cryptocurrency digital wallet. Second entity 508 may have second entity digital wallet 520. Second entity digital wallet 520 may be any digital wallet, such as a cryptocurrency digital wallet, without limitation. First entity digital wallet 516 and second entity digital wallet 520 may have corresponding wallet addresses or other wallet identification. System 500 may include orchestrator 512. Orchestrator 412 may be a software application that may be in communication with first entity digital wallet 516 and/or second entity digital wallet 520. Orchestrator 512 may be programmed and/or configured to communicate data between first entity digital wallet 516 and/or second entity digital wallet 520. In some embodiments, orchestrator 512 may be in communication with securities entity 536. A “securities entity” as used in this disclosure is an organization or individual that provides assets to an entity. Assets may include, but are not limited to, currencies, physical assets, digital assets, and the like. Assets may be as described above with reference to FIG. 1.

In some embodiments, orchestrator 512 may be configured to generate digital certificate 524. Digital certificate 524 may be a non-fungible token (NFT). In some embodiments, orchestrator 512 may generate digital certificate 524 base don a transfer of ownership, such as a transfer of ownership 136 as described above in FIG. 1. Digital certificate 524 may include digital certificate data 532. Digital certificate data 532 may include, but is not limited to, owner verification, asset authentication, asset identification, asset value, product information, digital address of one or more entities, and/or any other data that may be generated in the transfer of a physical asset 108 and/or digital twin 120 as described above with reference to FIG. 1. In some embodiments, digital certificate data 532 may include securities data. Securities data may include one or more policies for the protection of the physical and/or digital value of one or more assets. Policies may include insurances, such as physical asset insurance, digital asset insurance, and the like. Insurance policies may be provided by securities entity 536. In some embodiments, digital certificate data 532, including insurance policies, may be included in the digital certificate 524 at the time of minting or otherwise producing digital certificate 524.

Still referring to FIG. 5, in some embodiments, first entity 504 may provide an asset for ownership transfer to orchestrator 512. Assets may be as described above with reference to FIG. 1. Second entity 508 may opt into the minting of digital certificate 524 through orchestrator 512. Second entity may request security of an asset, such an insurance policy, through orchestrator 512. Orchestrator 512 may requests security of an asset, such as an insurance policy, from securities entity 536. Securities entity 536 may provide a securities policy, such as an insurance policy, to orchestrator 512. A securities policy may include one or more costs for implanting the securities policy. Orchestrator 512 may provide a securities policy as well as cost information to second entity 508. Second entity 508 may confirm an acquiring of an asset from first entity 504 and/or securities policy from securities entity 536 and may provide physical or digital value, such as currency, to orchestrator 512. Orchestrator 512 may prepare digital certificate data 532, which may include identification of first entity 504 and/or second entity 508, asset identification, asset value, dates, times, securities entity 536 identification, securities policy identification, and/or other data as described above with reference to FIG. 1. First entity 504 and/or second entity 508 may provide digital signatures to orchestrator 512 for the generation of digital certificate 524. Orchestrator 512 may mint or otherwise generate digital certificate 524 with digital certificate data 532. Digital certificate 524 may be stored in immutable sequential listing 528, which may include any type of blockchain, such as Ethereum, Avalanche, Polygon, and/or other blockchains.

In some embodiments, digital certificate 524, having digital certificate data 532, may be used as a form of collateral for a loan between two or more entities. In some embodiments, first entity 504 may agree to lend currency to orchestrator 512 in a form of a loan to second entity 508. Second entity 508 may accept a loan from first entity 504 and agree to collateralize a loan with digital certificate 524 through a collateralization contract, which may be generated and/or implemented by orchestrator 512. A collateralization contract may specify under what conditions use of and/or distribution of digital certificate 524 may be prevented. For instance, securities entity 536 may be able to take ownership of digital certificate 524 based on a securities policy of digital certificate 524. As a non-limiting example, second entity 508 may not be able to pay first entity 504 for an asset, in which securities entity 536 may be able to take over ownership of digital certificate 524. Securities policies of digital certificate 524 may include conditions that, if met, may allow securities entity 536 to assume ownership of digital certificate 524. Conditions may include, but are not limited to, failing to provide values of currency, loss of an asset, damage to an asset, and the like. One or more conditions of a security policy may, if met, block any operations to digital certificate 524. For instance, and without limitation, second entity 508 may miss a payment to first entity 504, in which operations of transferring of ownership of digital certificate 524 may be blocked by orchestrator 512. In some embodiments, a blocking of operations of digital certificate 524 may be temporary. For instance, and without limitation, continuing the above example, second entity 508 may pay any required amount of currency to first entity 504, which may unlock digital certificate 524 for further operations by orchestrator 512.

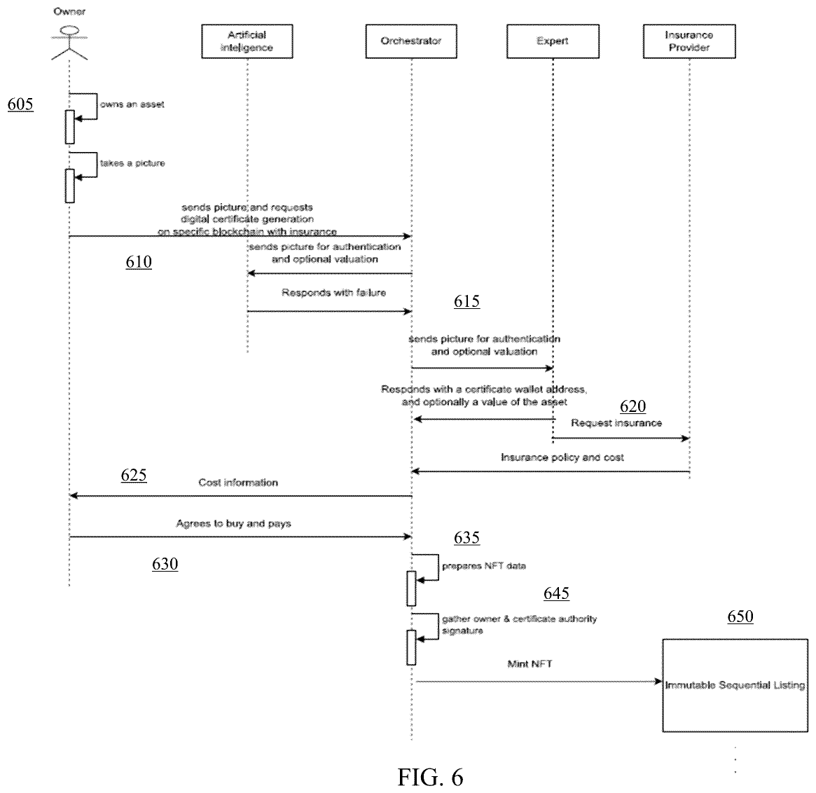

Referring now to FIG. 6, a flowchart for a method 600 of providing certificate authority of an asset is illustrated. At step 605, method 600 includes obtaining a picture of an asset. A picture of the asset may be obtained through a camera, such as a smartphone camera, tablet camera, or other camera. In some embodiments, a Lidar sensor may be used to take a three-dimensional picture of the asset. In some embodiments, a plurality of pictures may be obtained, such as at varying angles, resolutions, focuses, and the like. Pictures of two or more differing assets may captured, in some embodiments. As a non-limiting example, a user or owner may obtain pictures of two different pairs of shoes, a pair of shoes and a pair of sunglasses, or other assets.

At step 610, the picture of the asset is sent to an orchestrator along with a request for digital certification generation on a specific blockchain with a securities policy. The picture of the asset may be sent via a wired or wireless communication. In some embodiments, a plurality of pictures of the asset may be sent to the orchestrator. In some embodiments, two or more different assets pictures may be sent to the orchestrator simultaneously for authentication. The orchestrator may be as described above with reference to FIG. 5.

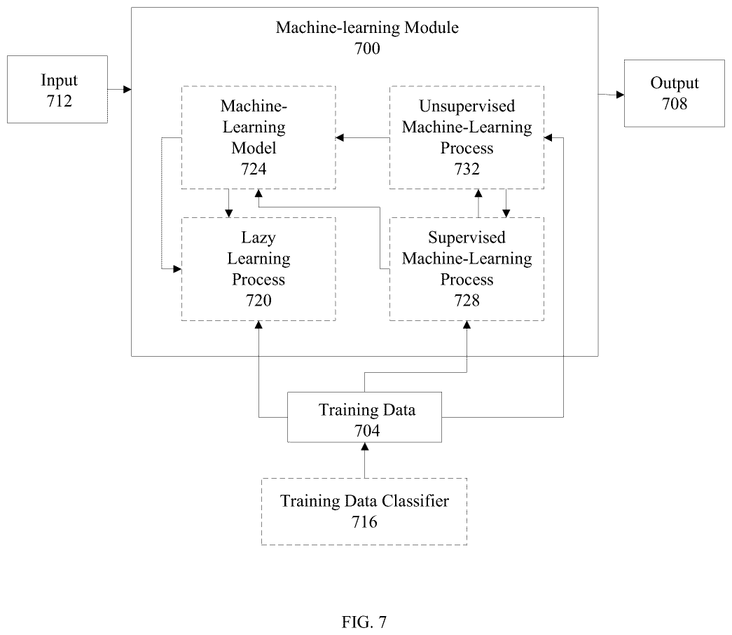

At step 615, the picture of the asset is sent to a certificate authority for authentication. A “certificate authority” as used in this disclosure is an entity which unequivocally certifies than an asset is authentic. A certificate authority may be a seller, artificial intelligence, expert, or other entity. In the method of 600, the certificate authority takes the form of an artificial intelligence. The artificial intelligence may receive the picture from the orchestrator for authentication. The artificial intelligence may include a computer vision or other machine learning model, such as machine learning modules as described below with reference to FIG. 7.

The artificial intelligence may be trained with training data correlating pictures to physical assets. As a non-limiting example, training data may include photographs of shoes corresponding to particular shoe products, which may include shoe sizes, shoe values, shoe release dates, and the like. Training data may be received through user input, external computing devices, and/or previous iterations of processing. The artificial intelligence may provide an authentication of the picture. An authentication of the picture may include an affirmation that a physical asset represented by the picture is accurately represented, and in some embodiments may include a valuation of the physical asset based on the picture. In some embodiments, the artificial intelligence may not be able to authenticate the picture in which case the orchestrator may send the picture to an expert for authentication and valuation. Either the artificial intelligence or expert may provide the orchestrator with authentication of the picture and/or valuation of the physical asset represented by the picture.

At step, 620 the orchestrator or the expert requests insurance policies from an insurance provider. Insurance policies may include conditions of payment, such as monthly payments, lump sum payments, and or other payments. Insurance policies may include dates and times, such as deadlines for payment, coverage, and the like. In some embodiments, the orchestrator may request multiple insurance policies for multiple assets. Insurance policies for two different assets may differ, such as in price, coverage, or other conditions.

At step 625, the insurance provider provides the insurance policy and cost to the orchestrator. The insurance policy may be as described above in step 620.

At step 630, the insurance policy and/or cost information related to the insurance policy may be provided to the owner. The owner may agree to acquire the insurance policy, such as through a graphical user interface (GUI).

At step 635, the orchestrator receives confirmation of the insurance policy and prepares data for inclusion in a digital certificate. The digital certificate may be an NFT. Data that may be used in generating the digital certificate may include digital certificate data as described above.

At step 640, the orchestrator receives signatures from the owner and any certificate authority. Signatures may include digital signatures, accepting one or more boxes displayed through a GUI, and/or other forms of consent.

At step 645, the orchestrator mints a digital certificate in the form of an NFT. The digital certificate may include owner information, asset valuation, asset authentication, insurance policies, asset identification, and/or other data. The digital certificate may be posted to an immutable sequential listing, such as a blockchain. The blockchain may be selected by the owner. In some embodiments, the asset authentication, since it may be stored in the NFT, may be traced back to and used to prove authenticity of an asset, such as in a case of transferring assets between two or more parties.

Referring to FIG. 7, an exemplary machine-learning module 700 may perform machine-learning process(es) and may be configured to perform various determinations, calculations, processes and the like as described in this disclosure using a machine-learning process.

Still referring to FIG. 7, machine learning module 700 may utilize training data 704. For instance, and without limitation, training data 704 may include a plurality of data entries, each entry representing a set of data elements that were recorded, received, and/or generated together. Training data 704 may include data elements that may be correlated by shared existence in a given data entry, by proximity in a given data entry, or the like. Multiple data entries in training data 704 may demonstrate one or more trends in correlations between categories of data elements. For instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 704 according to various correlations. Correlations may indicate causative and/or predictive links between categories of data elements, which may be modeled as relationships such as mathematical relationships by machine-learning processes as described in further detail below. Training data 704 may be formatted and/or organized by categories of data elements. Training data 704 may, for instance, be organized by associating data elements with one or more descriptors corresponding to categories of data elements. As a non-limiting example, training data 704 may include data entered in standardized forms by one or more individuals, such that entry of a given data element in a given field in a form may be mapped to one or more descriptors of categories. Elements in training data 704 may be linked to descriptors of categories by tags, tokens, or other data elements. Training data 704 may be provided in fixed-length formats, formats linking positions of data to categories such as comma-separated value (CSV) formats and/or self-describing formats. Self-describing formats may include, without limitation, extensible markup language (XML), JavaScript Object Notation (JSON), or the like, which may enable processes or devices to detect categories of data.

With continued reference to refer to FIG. 7, training data 704 may include one or more elements that are not categorized. Uncategorized data of training data 704 may include data that may not be formatted or containing descriptors for some elements of data. In some embodiments, machine-learning algorithms and/or other processes may sort training data 704 according to one or more categorizations. Machine-learning algorithms may sort training data 704 using, for instance, natural language processing algorithms, tokenization, detection of correlated values in raw data and the like. In some embodiments, categories of training data 704 may be generated using correlation and/or other processing algorithms. As a non-limiting example, in a body of text, phrases making up a number “n” of compound words, such as nouns modified by other nouns, may be identified according to a statistically significant prevalence of n-grams containing such words in a particular order. For instance, an n-gram may be categorized as an element of language such as a “word” to be tracked similarly to single words, which may generate a new category as a result of statistical analysis. In a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 704 to be made applicable for two or more distinct machine-learning algorithms as described in further detail below. Training data 704 used by machine-learning module 700 may correlate any input data as described in this disclosure to any output data as described in this disclosure, without limitation.

Further referring to FIG. 7, training data 704 may be filtered, sorted, and/or selected using one or more supervised and/or unsupervised machine-learning processes and/or models as described in further detail below. In some embodiments, training data 704 may be classified using training data classifier 716. Training data classifier 716 may include a classifier. A “classifier” as used in this disclosure is a machine-learning model that sorts inputs into one or more categories. Training data classifier 716 may utilize a mathematical model, neural net, or program generated by a machine learning algorithm. A machine learning algorithm of training data classifier 716 may include a classification algorithm. A “classification algorithm” as used in this disclosure is one or more computer processes that generate a classifier from training data. A classification algorithm may sort inputs into categories and/or bins of data. A classification algorithm may output categories of data and/or labels associated with the data. A classifier may be configured to output a datum that labels or otherwise identifies a set of data that may be clustered together. Machine-learning module 700 may generate a classifier, such as training data classifier 716 using a classification algorithm. Classification may be performed using, without limitation, linear classifiers such as without limitation logistic regression and/or naive Bayes classifiers, nearest neighbor classifiers such ask-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 716 may classify elements of training data to one or more physical or digital assets.

Still referring to FIG. 7, machine-learning module 700 may be configured to perform a lazy-learning process 720 which may include a “lazy loading” or “call-when-needed” process and/or protocol. A “lazy-learning process” may include a process in which machine learning is performed upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 704. Heuristic may include selecting some number of highest-ranking associations and/or training data 704 elements. Lazy learning may implement any suitable lazy learning algorithm, including without limitation a K-nearest neighbors algorithm, a lazy naive Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Still referring to FIG. 7, machine-learning processes as described in this disclosure may be used to generate machine-learning models 724. A “machine-learning model” as used in this disclosure is a mathematical and/or algorithmic representation of a relationship between inputs and outputs, as generated using any machine-learning process including without limitation any process as described above, and stored in memory. For instance, an input may be sent to machine-learning model 724, which once created, may generate an output as a function of a relationship that was derived. For instance, and without limitation, a linear regression model, generated using a linear regression algorithm, may compute a linear combination of input data using coefficients derived during machine-learning processes to calculate an output. As a further non-limiting example, machine-learning model 724 may be generated by creating an artificial neural network, such as a convolutional neural network comprising an input layer of nodes, one or more intermediate layers, and an output layer of nodes. Connections between nodes may be created via the process of “training” the network, in which elements from a training data 704 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 7, machine-learning algorithms may include supervised machine-learning process 728. A “supervised machine learning process” as used in this disclosure is one or more algorithms that receive labelled input data and generate outputs according to the labelled input data. For instance, supervised machine learning process 728 may include pictures as described above as inputs, certified authentications as outputs, and a scoring function representing a desired form of relationship to be detected between inputs and outputs. A scoring function may maximize a probability that a given input and/or combination of elements inputs is associated with a given output to minimize a probability that a given input is not associated with a given output. A scoring function may be expressed as a risk function representing an “expected loss” of an algorithm relating inputs to outputs, where loss is computed as an error function representing a degree to which a prediction generated by the relation is incorrect when compared to a given input-output pair provided in training data 704. Persons skilled in the art, upon reviewing the entirety of this disclosure, will be aware of various possible variations of at least a supervised machine-learning process 528 that may be used to determine relation between inputs and outputs. Supervised machine-learning processes may include classification algorithms as defined above.

Further referring to FIG. 7, machine learning processes may include unsupervised machine-learning processes 732. An “unsupervised machine-learning process” as used in this disclosure is a process that calculates relationships in one or more datasets without labelled training data. Unsupervised machine-learning process 732 may be free to discover any structure, relationship, and/or correlation provided in training data 704. Unsupervised machine-learning process 732 may not require a response variable. Unsupervised machine-learning process 732 may calculate patterns, inferences, correlations, and the like between two or more variables of training data 704. In some embodiments, unsupervised machine-learning process 732 may determine a degree of correlation between two or more elements of training data 704.

Still referring to FIG. 7, machine-learning module 700 may be designed and configured to create a machine-learning model 724 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of I divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 7, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naive Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

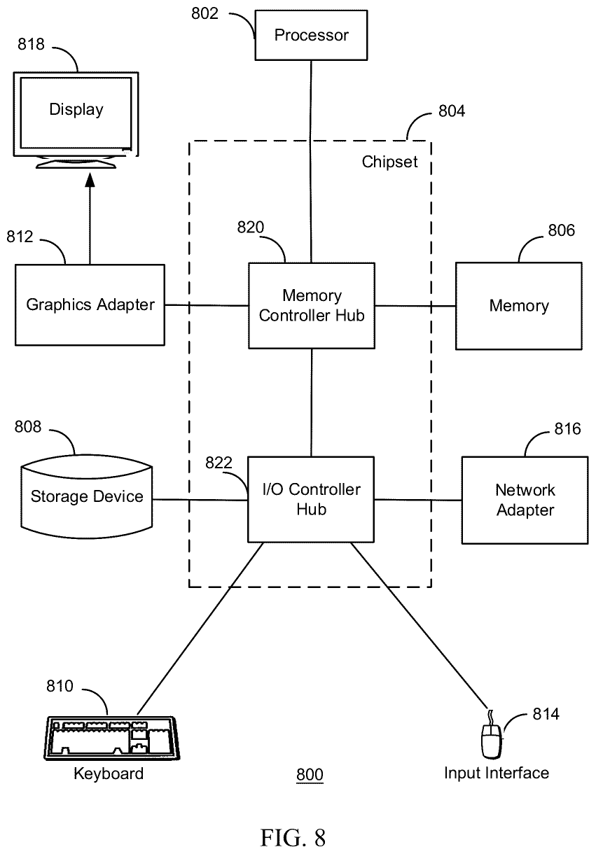

FIG. 8 illustrates an example computer for implementing the systems and methods as described herein. In some embodiments, the computing device includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, an input interface 814, and network adapter 816 are coupled to the I/O controller hub 822. Other embodiments of the computing device have different architectures.

The storage device 808 is a non-transitory computer-readable storage medium such as a hard drive, compact disk read-only memory (CD-ROM), DVD, or a solid-state memory device. The memory 806 holds instructions and data used by the processor 802. The input interface 814 is a touch-screen interface, a mouse, track ball, or other type of input interface, a keyboard, or some combination thereof, and is used to input data into the computing device. In some embodiments, the computing device may be configured to receive input (e.g., commands) from the input interface 814 via gestures from the user. The graphics adapter 812 displays images and other information on the display 818. The network adapter 816 couples the computing device to one or more computer networks.

The graphics adapter 812 displays representations, graphs, tables, and other information on the display 818. In various embodiments, the display 818 is configured such that the user (e.g., data scientists, data owners, data partners) may input user selections on the display 818. In one embodiment, the display 818 may include a touch interface. In various embodiments, the display 818 can show one or more predicted lead time for providing a customer order.

The computing device 800 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 808, loaded into the memory 806, and executed by the processor 802.

The types of computing devices 800 can vary from the embodiments described herein. For example, a system can run in a single computer 800 or multiple computers 800 communicating with each other through a network such as in a server farm. In another example, the computing device 800 can lack some of the components described above, such as graphics adapters 812, input interface 814, and displays 818.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative, procedural, or functional languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array), an ASIC (application specific integrated circuit), non von neumann architectures, neuromorphic chips, and deep learning chips.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto optical disks, optical disks, or solid state drives. However, a computer need not have such devices. Moreover, a computer can be embedded in another device, e.g., a smart phone, a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including, by way of example, semiconductor memory devices, e.g., EPROM, EEPROM, and flash memory devices; magnetic disks, e.g., internal hard disks or removable disks; magneto optical disks; and CDROM and DVD-ROM disks. The processor and the memory can be supplemented by, or incorporated in, special purpose logic circuitry.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A system for physical asset verification, comprising:
a computing device configured to:
receive asset data of a physical asset, wherein the asset data includes a unique object identifier;
generate a digital twin database based on the asset data, wherein the digital twin database includes a digital twin of the physical asset, wherein the digital twin is stored in an immutable sequential listing;
receive an asset transfer code at a transfer point of the physical asset;
authenticate, at the transfer point, the physical asset based on the unique object identifier and the asset transfer code; and
assign ownership of the digital twin to a user at the transfer point based on the authentication.

2. The system of claim 1, wherein the computing device is further configured to store the ownership assignment of the digital twin to the user in the immutable sequential listing.

3. The system of claim 1, wherein the computing device is further configured to:
generate a unique digital link to a server in response to receiving the asset transfer code;
receive a verification code from the user through the server;
match the verification code with the asset transfer code; and
authenticate the verification code as belonging to the digital twin.

4. The system of claim 3, wherein the unique digital link includes a URL link.

5. The system of claim 1, wherein the computing device is further configured to assign an ownership identification to the user and store the assignment of the ownership identification on the immutable sequential listing.

6. The system of claim 1, wherein the computing device is further configured to receive the asset transfer code at the transfer point through a scanning device, wherein the scanning device scans a product identifier of the physical asset and generates an asset transfer code.

7. The system of claim 6, wherein the product identifier includes a barcode and the scanning device scans the barcode of the product identifier of the physical asset and generates a digital link to a server.

8. The system of claim 1, wherein, the computing device is further configured to encrypt the unique object identifier and the asset transfer code through an encryption process.

9. The system of claim 1, wherein the digital twin includes one of a non-fungible token (NFT), token on a block chain, or soul-bound token.

10. The system of claim 1, wherein the computing device is further configured to authenticate the physical asset as a function of a double handshake protocol.

11. A method of physical asset verification using a computing device, comprising:
receiving asset data of a physical asset, wherein the asset data includes a unique object identifier;
generating a digital twin database based on the asset data, wherein the digital twin database includes a digital twin of the physical asset, wherein the digital twin is stored in an immutable sequential listing;
receiving an asset transfer code from a user at a transfer point of the physical asset;
authenticating, at the transfer point, the physical asset based on the unique object identifier and the asset transfer code; and
assigning an ownership of the digital twin to the user at the transfer point based on the authentication.

12. The method of claim 11, further comprising storing the ownership assignment of the digital twin to the user in the immutable sequential listing.

13. The method of claim 11, wherein authenticating further comprises:
generating a unique digital link to a server in response to receiving the asset transfer code;
receiving a verification code from the user through the server;
matching the verification code with the asset transfer code; and
authenticating the verification code as belonging to the digital twin.

14. The method of claim 13, wherein the unique digital link includes a URL link.

15. The method of claim 11, further comprising assigning an ownership identification to the user and storing the assignment of the ownership identification on the immutable sequential listing.

16. The method of claim 11, wherein receiving the asset transfer code further comprises receiving the asset transfer code at the transfer point through a scanning device, wherein the scanning device scans the physical asset and retrieves an asset transfer code through an application programming interface request of the digital twin database.

17. The method of claim 16, wherein the scanning device scans a barcode of the physical asset and retrieves the asset transfer code from the barcode of the physical asset through an application programming interface (API).

18. The method of claim 11, wherein, further comprising encrypting the unique object identifier and the asset transfer code through an encryption process.

19. The method of claim 11, wherein the digital twin includes one of a non-fungible token (NFT), token on a block chain, or soul-bound token.

20. The method of claim 11, wherein the authenticating the asset transfer code further comprises authenticating the physical asset as a function of a double handshake protocol.
